(19) United States
(12) Patent Application Publication
(10) Pub. No.: US 2026/0087537 A1
(43) Pub. Date: Mar. 26, 2026

(54) SYSTEMS AND METHODS FOR GENERATING A CUSTOMIZED ONLINE ENVIRONMENT FOR PROCUREMENT

(71) Applicant: Folio Services, Inc., Durham, NC (US)

(72) Inventors: Kathlyn Adamson, Durham, NC (US); Alexander Hertz, San Francisco, CA (US); Charles Harrington, Marin County, CA (US); Genevieve Liston, Orange County, CA (US)

(73) Assignee: Folio Services, Inc., Durham, NC (US)

(21) Appl. No.: 19/339,990

(22) Filed: Sep. 25, 2025

Related U.S. Application Data
(60) Provisional application No. 63/699,106, filed on Sep. 25, 2024.

(51) Int. Cl. G06Q 30/0601; H04L 9/40

(52) U.S. Cl. CPC G06Q 30/06311; G06Q 30/0641; H04L 63/102

(57) ABSTRACT

Disclosed herein are methods and systems for generating a customized online environment for procuring products. The method includes extracting an account identifier from procurement history data for an entity, where the account identifier is associated with a third-party system. The method further includes generating a profile with the third-party system and associating the profile with the account identifier. Next, an online environment is generated that lists or displays at least one product associated with the third-party system for procurement thereof. The method further includes receiving a request, via the online environment, from the entity to procure the at least one product. Finally, the method includes accessing the profile on the third-party system and submitting a procurement request for the at least one product.

### CROSS-REFERENCE TO RELATED APPLICATIONS

This is a non-provisional conversion of, and claims the benefit of the filing date of, pending U.S. Provisional Patent Application Ser. No. 63/699,106, filed Sep. 25, 2024, entitled “Systems and Methods for Custom Store Creation for Optimized, Mobile Purchasing at a Property”, the entirety of which application is incorporated by reference herein.

### FIELD OF DISCLOSURE

The present disclosure relates generally to online computing environments. More particularly, the present disclosure relates to systems and methods for generating a customized online environment for procuring products.

### BACKGROUND

Hotels, resorts, and other properties typically manage procurement through a centralized purchasing department or a network of specialized buyers who source equipment, food, and inventory based on guest demand, seasonal trends, and brand standards. These establishments often work with approved vendors and suppliers to ensure consistency in quality and pricing. For food and beverage items, procurement is usually done on a recurring basis, with fresh produce and perishables ordered daily or weekly, while dry goods and beverages may be stocked in bulk. Equipment such as kitchen appliances, linens, and furniture are purchased less frequently and often involve long-term contracts or capital expenditure planning.

Inventory management systems play a crucial role in tracking usage and forecasting needs, helping properties avoid shortages or overstocking. Resorts with multiple outlets, like restaurants, spas, and recreational facilities, often use integrated software to streamline ordering and monitor consumption across departments. Sustainability and local sourcing have become increasingly important, with many entities prioritizing eco-friendly products and partnerships with nearby farms or artisans. Ultimately, the goal is to maintain a seamless guest experience by ensuring that all necessary items are available, functional, and aligned with the brand's service standards.

Hotels, resorts, and other properties often face logistical and operational challenges when ordering supplies from multiple vendors. One major issue is coordination, managing delivery schedules, payment terms, and product specifications across various suppliers can lead to delays, miscommunication, or inconsistencies in quality. For example, if a food vendor delivers late or provides subpar ingredients, it can disrupt kitchen operations and negatively impact guest satisfaction. Similarly, equipment orders may be delayed due to supply chain disruptions or vendor backlogs, affecting maintenance schedules or room readiness. These problems are compounded when entities operate in remote locations or during peak seasons when demand surges.

There is therefore a need for improved systems to aid hotel and resorts management in product, equipment, inventory, and services procurement.

### BRIEF SUMMARY

This summary is provided to introduce a selection of concepts in a simplified form that are further described below in the detailed description. This summary is not intended to identify key features or essential features of the claimed subject matter, nor is it intended as an aid in determining the scope of the claimed subject matter.

In a first aspect, the subject matter herein provides a method for generating a customized online environment for procurement. In some embodiments, the method includes accessing procurement history data of an entity. The method further includes extracting, from the procurement history data, an account identifier for the entity, the account identifier associated with a third-party system; The method further includes generating a profile with the third-party system and associating the profile with the account identifier. The method further includes generating an online environment listing at least one product associated with the third-party system for procurement thereof. The method further includes receiving a request, via the online environment, from the entity to procure the at least one product. The method further includes accessing the profile on the third-party system and submitting a procurement request for the at least one product.

In another aspect, the subject matter herein provides a system for generating a customized online environment for procurement. In some embodiments, the system comprises a processing circuit; and a memory coupled to the processing circuit, the memory including instructions which when executed by the processing circuit cause the processing circuit to perform various operations. In some embodiments, the processing circuit is caused to access procurement history data of an entity. In some embodiments, the processing circuit is caused to extract, from the procurement history data, an account identifier for the entity, the account identifier associated with a third-party system. In some embodiments, the processing circuit is caused to generate a profile with the third-party system and associate the profile with the account identifier. In some embodiments, the processing circuit is caused to generate an online environment listing at least one product associated with the third-party system for procurement thereof. In some embodiments, the processing circuit is caused to receive a request, via the online environment, from the entity to procure the at least one product. In some embodiments, the processing circuit is caused to access the profile on the third-party system and submit a procurement request for the at least one product.

In another aspect, the subject matter herein provides a non-transitory computer-readable storage medium having executable instructions stored thereon for generating a customized online environment for procurement. In some embodiments, the instructions are executed by a processing circuit causing the processing circuit to perform various operations. In some embodiments, the processing circuit is caused to access procurement history data of an entity. In some embodiments, the processing circuit is caused to extract, from the procurement history data, an account identifier for the entity, the account identifier associated with a third-party system. In some embodiments, the processing circuit is caused to generate a profile with the third-party system and associate the profile with the account identifier. In some embodiments, the processing circuit is caused to generate an online environment listing at least one product associated with the third-party system for procurement thereof. In some embodiments, the processing circuit is caused to receive a request, via the online environment, from the entity to procure the at least one product. In some embodiments, the processing circuit is caused to access the profile on the third-party system and submit a procurement request for the at least one product.

Further features and advantages of at least some of the examples of the present disclosure, as well as the structure and operation of various examples of the present disclosure, are described in detail below with reference to the accompanying drawings.

### BRIEF DESCRIPTION OF THE SEVERAL VIEWS OF THE DRAWINGS

Provided below is a brief description of the several views of the drawings which illustrate various features of some examples of the present disclosure. The various drawings are described in more detail in the Detailed Description that follows. To easily identify the discussion of any particular element or act, the most significant digit or digits in a reference number refer to the figure number in which that element is first introduced.

FIG. 1 is a block diagram of an example system in accordance with some embodiments.

FIG. 2 is an architecture diagram in accordance with some embodiments.

FIG. 3 is a logical flow diagram in accordance with some embodiments.

FIG. 4 is a flow chart illustrating some example operations performed in a method in accordance with some embodiments.

FIG. 5 is a block diagram of a computer architecture in accordance with embodiments.

FIG. 6 is a block diagram of an example communication environment in accordance with embodiments.

It should be understood that the drawings are not necessarily to scale and that the disclosed examples are sometimes illustrated diagrammatically and in partial views. In certain instances, details which are not necessary for an understanding of the disclosed methods and devices or which render other details difficult to perceive may have been omitted. It should be further understood that this disclosure is not limited to the particular examples illustrated herein. In the drawings, like numbers refer to like elements throughout unless otherwise noted.

### DETAILED DESCRIPTION

The following description of embodiments provides non-limiting representative examples referencing numerals to particularly describe features and teachings of different aspects of the present disclosure. The embodiments described should be recognized as capable of implementation separately, or in combination, with other embodiments from the description of the embodiments. A person of ordinary skill in the art reviewing the description of embodiments should be able to learn and understand the different described aspects of the disclosure. The description of embodiments should facilitate understanding of the disclosure to such an extent that other implementations, not specifically covered but within the knowledge of a person of skill in the art having read the description of embodiments, would be understood to be consistent with an application of the disclosure.

The described features and teachings of the embodiments may be combined in any suitable manner. A person of ordinary skill in the art will recognize that the embodiments may be practiced without one or more of the specific features and teachings of an embodiment. In other instances, additional features and teachings may be recognized in certain embodiments that may not be present in all embodiments. A person of ordinary skill in the art will understand that the described features and teachings of any embodiment can be interchangeably combined with the features and teachings of any other embodiment.

Properties, such as hotels, restaurants, resorts or casinos, have very unique purchasing needs. Given the often high-turnover and distributed nature of an entity's workforce, the often separate entities who buy vs. pay for the goods and services, space and storage constraints, the frequency and variety of buying, and specific brand values or brand requirements, the process of procuring products and services (e.g., inventory, food, supplies, and equipment) requires that supervision and controls are in place to ensure the right products are being purchased from the right suppliers, and to prevent rogue purchasing or unnecessary overspending. These controls are often implemented using “e-Procurement” or “Procure-to-pay” platforms.

Those who make purchases (“buyers” or “purchasers”) on the ground at an entity are more and more on-the-go. They are often moving something through the space (a guest or a good), logging “eyes up time” serving visitors, or taking inventory in places where they do not have a desktop computer. In addition, time is precious. These buyers benefit from the modern benefits of seamless and efficient checkout experiences to be effective, efficient workers. Moreover, the ground staff making these purchases have high turnover. New staff that take their place may not always have knowledge of restocking, where to procure products and services, or what to procure.

Properties often employ many buyers with different roles, needs and levels of urgency. Meanwhile, space and storage continue to be constrained, so entities cannot hold inventory. They tend to want to buy from a convenient option. There are often economies of scale when consolidating purchasing across an entity to unlock savings or streamline the operations of the whole entity. So, an item may be purchased in bulk, but distributed across an entity and its multiple outlets.

There is a significant amount of information for buyers to consider when making a purchase to drive optimal outcomes for the entity. Considerations may include the cost of the good, the supplier they are purchasing from, the specific brand values or requirements associated with the entity, the needs of the organization at a given moment, or the forecast of the future needs. That information lives in many different places, and can be complicated to assemble, let alone process at the point of purchase.

When an entity is buying a product, good, or service, there are often preferred suppliers for that particular good for an entity. Because entities or their operating companies are repeatedly buying specific goods and services, these companies often execute contracts with specific suppliers with negotiated pricing, sometimes through a Group Purchasing Organization (GPO). Those contracts can contain terms for discounts overall or on a product-specific level, and may have specific thresholds of purchasing that unlock additional discounts or additional incentives, such as through a specific volume, frequency, or committed share of buying.

Often, getting a procurement program setup and rolled out across an organization is quite time consuming. It can often take 6-8 weeks to configure one entity's storefront and have it ready for operators on-site to shop and place orders.

The present disclosure relates to generating a custom store for buyers at an entity, considering their unique suppliers and a wide variety of buying dimensions, incentives and requirements, and then presents those products and carts in a manner that maximizes cost savings and other benefits. Inputs are specific data attributes and processes that systems and methods knows to access and retrieve, depending on the systems and technologies in use with the entity, and the output is a functional, custom, optimized-for-mobile ecommerce store for its buyers.

Embodiments for custom store creation discussed herein present numerous technical advantages over existing system. For example, efficiencies in ordering from contracted suppliers, particularly given the high-turnover workforce, can be realized.

It is incontrovertible that online procurement systems are technologies or technical fields. Embodiments of the present disclosure improve these technical fields or technologies by improving the experience for users and entities that spend time procuring products and services described herein. For example, embodiments of the present disclosure improve existing systems by automatically assembling a customized storefront that allows the entity to procure products and services from disparate vendors and third-parties all at the same location instead of in different, disparate locations. This improves the technology of online ordering environments and systems because it places relevant products and services at the same location. Moreover, the systems and methods described herein automatically generates user profiles on third-party vendor websites and automatically obtains account identifier information for the entity, and associates the newly generated profile with the account identifier information for the entity. The account identifier information is managed by the third-party system (e.g., vendor) and is assigned to the entity.

As another example, financial discipline and spend controls seamlessly integrated at checkout can be implemented. As another example, embodiments for custom store creation provide for an optimized cart creation to maximize benefits and minimize fees to benefit the bottom-line of an entity from a financial perspective. In addition, optimized cart creation to ensure efficient and optimal entity operations. As another example, embodiments for custom store creation provide for increased supplier revenues as a result of more distributed, user-friendly, mobile purchasing.

As another example, embodiments for custom store creation provide for improved guest experiences from more active and present buyers at an entity. As another example, embodiments for custom store creation provide for buyer efficiencies as buyers enjoy a faster, more efficient checkout processes with increased mobile access.

In embodiments, the generation of custom digital storefronts uses unique inputs for the retrieval of relevant information. Systems and methods of the present disclosure unify specific information from many disparate locations (e.g. static, online, or hard-coded during onboarding) and sources (e.g. spend history and reports, inventory reports, supplier websites, budgeting software, forecasting spreadsheets, supplier-provided information, product-specific information, accounting systems, invoices, spend categories, general ledger (GL)-codes, outlet information, contract terms with suppliers, group purchasing organization (GPO) dashboards or reports, contracts with suppliers).

In embodiments, the reports are unique to the entity (e.g. associated brand guidelines or requirements), the management company, the set of suppliers (e.g. real-time incentives on the product, cart, or contract-level, shipment details), and/or the brand of hotel. In further embodiments, the reports are unique to the software any of the foregoing entities are using.

In embodiments, the generation of custom digital storefronts uses data processing, extraction, and translation techniques. Systems and methods of the present disclosure employ a specialized processes for digesting the data, including data specific to the entity, brand, unique operation, technology providers, partners (such as GPOs), and suppliers, to extract the relevant information for store setup. In embodiments, the generation of custom digital storefronts implements the structural setup of the stores. Systems and methods of the present disclosure set up the store with specific users and controls, and “off the shelf” recommended rules (e.g. approval, match) that encourage more financial discipline. Systems and methods further customize the store based on the organization, brand, collection, ownership, type, management company or GPO, so, in the future, products can be recommended accordingly, and spend reports or specific products or order guides by supplier could be rolled out to specific entities.

In embodiments, the generation of custom digital storefronts implements a unified catalog setup. Conventionally, the process of adding a supplier to a procurement platform typically requires supplier action, and up to hundreds of manhours managing the overall process. Systems and methods of the present disclosure handles catalog setup with limited to no supplier involvement. In doing so, systems and methods use a variety of tools, processes, automations, and their own databases to set up suppliers and their catalog expediently. Systems and methods can further setup order guides based on these catalogs across multiple suppliers. Systems and methods can further tag the products based on the historical spend, user making the purchase, their entities'unique GL codes, the contract to which a product may apply.

In embodiments, the generation of custom digital storefronts performs ordering processes. Systems and methods of the present disclosure set up a store with the entity's unique set of suppliers for not just browsing, but also ordering, with limited to no effort by a supplier.

In embodiments, the generation of custom digital storefronts implements mobile-optimized designs. Systems and methods of the present disclosure manage and process the retrieved information from the entity to determine what information is most relevant and impactful to present to the buyer to inform an optimal purchase, with focus given to the presentation organization of information in the designs. Since there is a substantial amount of information to digest when making a purchase, systems and methods provide a mobile-optimized experience that helps guide the buyer to the most impactful purchase information and spend information.

In embodiments, the generation of custom digital storefronts performs an ongoing and/or continuous catalog synchronization. Systems and methods of the present disclosure implement automations, through which the latest supplier product information, including pricing, availability and descriptive information, can be retrieved.

In embodiments, the generation of custom digital storefronts incorporates supplier metadata. Suppliers offer discounts in a variety of complex ways and not just on an entity level: on a product level, across a basket of products, if minimums are met, if incentive thresholds are met on a cart or on a monthly basis. Systems and methods of the present disclosure can manage and maintain that information on a supplier-by-supplier basis, and can make it available to buyers, as relevant, to help them optimize discounts and rebates. Systems and methods can also display imperative information like cutoff times, or minimums (on a dollar or case basis), at checkout that can help avoid additional fees.

In embodiments, the generation of custom digital storefronts implements mobile-optimized approvals. Systems and methods of the present disclosure enable approvers to access approvals in a mobile-optimized way, across mobile devices (e.g. phone, glasses).

In embodiments, the generation of custom digital storefronts implements order placement. Once approvals are provided, systems and methods of the present disclosure enable the order to be placed in a way uniquely determined by supplier, informed by data provided by the entity, accounting system, and the supplier themselves.

In embodiments, the generation of custom digital storefronts gracefully handles adjustments. To the extent that there are adjustments post-order, systems and methods of the present disclosure enable those changes to be auditable.

In embodiments, the generation of custom digital storefronts enable easy reconciliation. As invoices are received, systems and methods of the present disclosure automatically applied GL coding from the purchase order (PO) to the invoices. Systems and methods can export the spend history in a format compatible with most accounting systems or enterprise resource planning (ERP) systems, for easier accounting or reconciliations.

The generation of custom digital storefronts and rapid customized store setup according to the present disclosure revolutionizes the traditional decentralized shopping processes and time-intensive energy of alternative procurement platforms by integrating cutting-edge information assembly techniques, processing, industry know-how, and innovative mobile design features. This present disclosure provides significant operational benefits for entities, creating a more efficient, convenient, and secure shopping and streamlined operations.

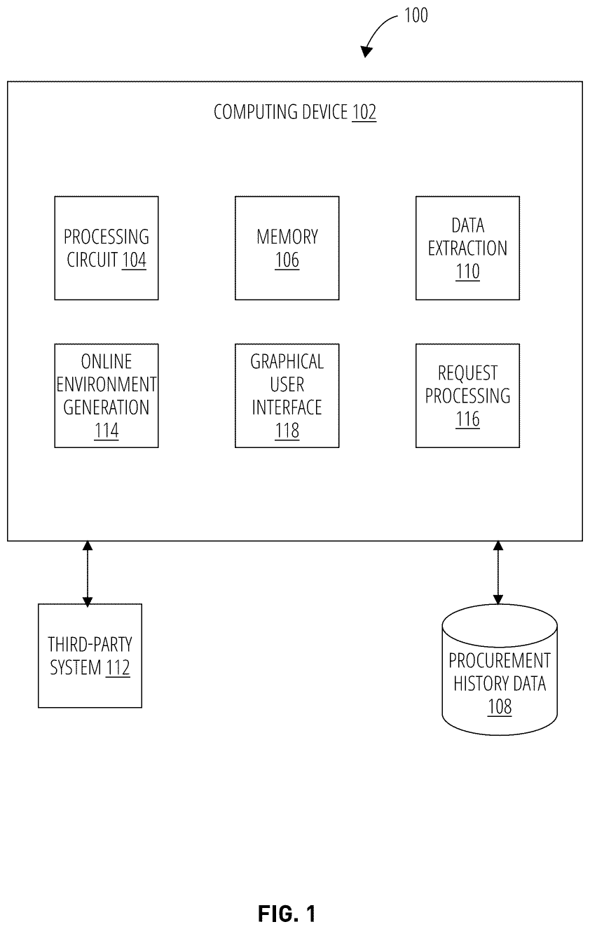

FIG. 1 is a block diagram of an example system 100 for generating a customized online environment for procuring products. In some embodiments, the system 100 includes a computing device 102, a third-party system 112, and a data store that includes procurement history data 108. In some embodiments, the computing device 102 includes a computer device, personal computer, server, cloud server, mobile device, tablet, tablet computer, iPad® made by Apple, Inc. or any other suitable computer or computing device. In some embodiments, the third-party system can likewise include a computer device, personal computer, server, cloud server, mobile device, tablet, tablet computer, iPad®, or any other suitable computer or computing device. In some embodiments, the data store that stores the procurement history data 108 can include a server, cloud server, cloud storage device, network storage device, hard drive, flash drive, solid state drive, storage area network device, or any other type of computing device capable of storing data.

In some embodiments, the computing device 102 includes a processing circuit 104, memory 106, and various functions for execution thereon. In some embodiments, the processing circuit 104 may comprise a processor, microprocessor, central processing unit (CPU), graphics processing unit (GPU), application specific integrated circuit (ASIC), single core processor, multi-core processor, or any other suitable processing circuit capable of performing operations described herein.

In some embodiments, the memory 106 comprises a non-transitory memory device, hard drive, solid state drive, flash memory, cache, random access memory (RAM), read only memory (ROM), non-volatile RAM (NVRAM), any combination of these, or any other suitable memory device capable of storing executable instructions for execution by the processing circuit 104. In some examples, the memory 106 has executable instructions stored thereon, which when accessed and executed by the processing circuit 104 configure the processing circuit 104 to perform various operations described herein.

In some embodiments, the computing device 102 includes several computer functions stored in the memory 106 and configured to be executed by the processing circuit 104. For example, the computing device 102 may include a data extraction 110 function, an online environment generation 114 function, a graphical user interface (GUI) 118 function, and an function for request processing 116.

In some embodiments, the computing device 102 is configured to communicate with the data store to access procurement history data 108 of an entity. The entity can include an organization such as a business, hotel, restaurant, resort, or casino. The entity can communicate with the computing device 102 to trigger accessing the procurement history data 108 of the entity. Additionally, the entity can share the procurement history data 108 with the computing device 108 or with the data store. In some embodiments of the present disclosure, the procurement history data includes one or more of invoice data, purchase history data, a receipt, order history data, count sheets, transactional data, payment records, vendor data, inventory data, operational data, maintenance and asset management data (e.g., service logs, parts and supply order, lifecycle tracking of assets, etc.), and digital systems logs.

In some embodiments, the processing circuit 104 is configured to execute the data extraction 110 function. This configures the processing circuit 104 to analyze the procurement history data 108 and then extract, from the procurement history data 108, an account identifier for the entity, the account identifier associated with a third-party system 112. In some embodiments, the account identifier is an account number with the third-party system 112, where the account number is assigned to the entity. For instance, the account number may be present on the invoice for a certain vendor, on a receipt, order form, or other data. In some embodiments, the third-party system 112 is a merchant website or server, online retail or wholesale website or server, or a website or server for ordering goods and services (e.g., a vendor website or server).

In some embodiments, the processing circuit 104 is further configured to generate a profile with the third-party system 112 and associate the profile with the account identifier. In some embodiments generating the profile with the third-party system 112 includes the processing circuit 104 being configured to communicate with the third-party system 112 to create the profile using new log-in credentials (e.g., different log-in credentials than what the entity would use). The processing circuit 104 is further caused to send a request to the third-party system 112 to associate the new profile with the account identifier to indicate to the third-party system that the new profile being generated is associated with or assigned to the entity.

In some embodiments, the processing circuit 104 is then configured to execute the online environment generation 114 function, thereby causing the processing circuit 104 to generate an online environment listing at least one product associated with the third-party system 112 for procurement thereof. For example, the processing circuit 104 can generate an online storefront, procurement webpage, customized marketplace, or other suitable environment for the entity to be able to purchase the at least one product associated with the third-party system 112.

In some examples, the online environment includes a set of products from the same vendor or from one or more vendors. In some embodiments, generating the online environment listing the at least one product associated with the third-party system includes the processing circuit being configured to generate an online environment configured as a personalized storefront for the entity, wherein the personalized storefront includes a graphical user interface (GUI) 118 to display or list the at least one product. In some embodiments, the processing circuit 104 is further configured to perform an analysis on the procurement history data 108 to determine the at least one product from the procurement history data. For example, the processing circuit 104 is configured to determine one or more products to display on the GUI of the personalized storefront based on repeated purchases of the products on the procurement history data. These repeated purchases can be daily, periodic, or even randomly, but common. The processing circuit 104 is then configured to display the at least one product on the GUI of the personalized storefront.

In some embodiments, the processing circuit 104 determines what products are displayed on the GUI of the personalized storefront by combining a broad catalog search with configurable algorithms that balance property-level needs (e.g., availability, convenience, etc.) and corporate priorities (e.g., cost, supplier contracts, etc.). customized storefront is configured to display catalog items across all suppliers, not just previously purchased items. Both available products and historically procured products are digitized to support full search, but curated to support the strategic priorities of the property.

Products and services are organized on the GUI of the personalized storefront based on order guides (e.g., curated sequences, brand requirements, etc.), favorites and custom lists, inventory module (e.g., sheet-to-shelf) for location-based organization, filtering and supplier preferences, and search results that can be filtered by historically purchased items, approved or contracted items, or specific suppliers/vendors. The system can identify substitutions or exact matches across suppliers. However, user configurations and strategies guide decisions. For example, substitutes may be recommended (e.g., alternate meat cuts), substitutes may be excluded where strict specifications apply, buyers may be nudged toward contracted items, and reporting provides insights into compliance with organization purchasing goals.

In some embodiments, once the customized storefront is generated and operational, the processing circuit 104 is configured to execute the request processing 116 function. This configures the processing circuit 104 to receive a request, via the online environment, from the entity to procure the at least one product. For example, the online environment may receive an order request for ordering the at least one product. The processing circuit 104 is then configured to access the profile on the third-party system 112 and submit a procurement request for the at least one product. This may include logging into the profile on the third-party system 112 and ordering the product from the third-party system 112 to be shipped to the entity. However, the entity itself does not have to directly communicate with the third-party system 112 at all.

Custom store generation according to systems and methods of the present disclosure provides a process of setting up a custom store for a specific entity to guide buyers towards optimal purchasing. This custom store generation is unique in that the systems and methods:
Know exactly which data and reports to use and how to combine this information with their own datasets;
Set up a complete, functional storefront with carefully curated suppliers and catalogs, along with industry best practices. They also suggest user access controls and rules;
Use technology that keeps the store updated and synced over time, so that it is not just configured, but performant over time; and
Optimize the store for mobile use, across all devices, to share important information and help achieve the best outcomes for the entity

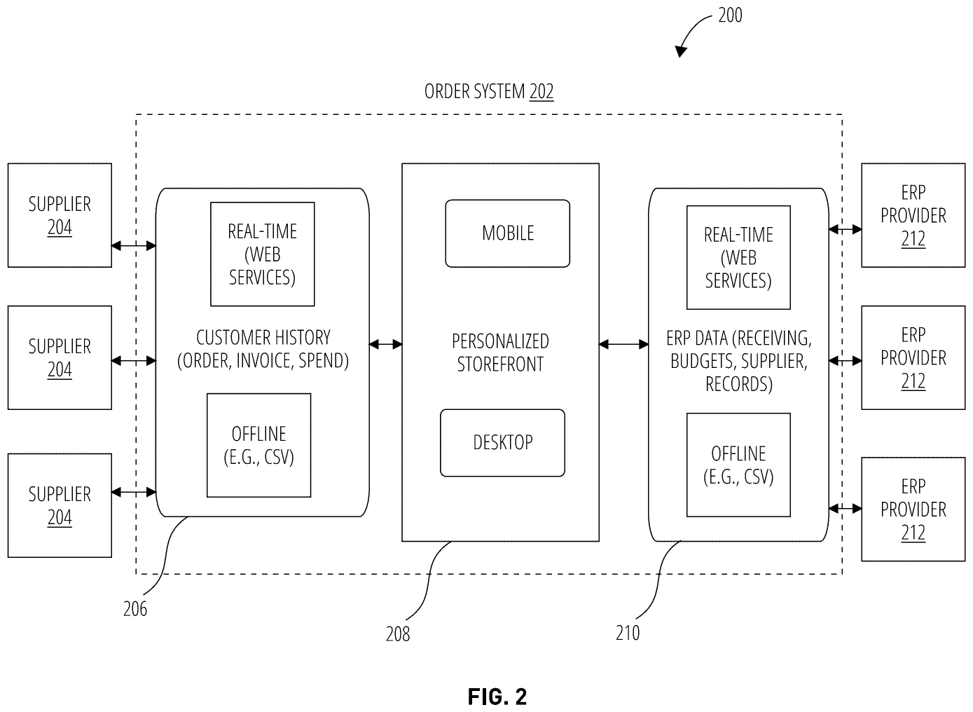

FIG. 2 illustrates an example computer system 200 or custom store creation for optimized mobile purchasing at an entity in accordance with embodiments. System 200 includes an order system 202, one or more supplier system(s) 204 and one or more resource planning system(s) 212. Features described herein can be implemented in combination with or separately from those described above for FIG. 1. For example, the order system 202 of FIG. 2 may also implement the operations and functions of the computing device 102 and processing circuit 104 described above (or vise-versa). Each of these systems are a combination of hardware, software, and sometimes other components that work together to process and manage information. Hardware includes physical elements like the central processing unit (CPU), memory (RAM), storage devices, input devices (keyboard, mouse), and output devices (monitor, printer). Software includes the operating system, which manages resources and provides a platform for applications, and various applications designed for specific tasks like word processing or web browsing. In some cases, computer systems may also incorporate additional elements such as network interfaces for connectivity or specialized hardware for specific functions. Essentially, a computer system is a versatile tool capable of handling a wide range of tasks, from basic calculations to intricate simulations and data analysis.

The order system 202 includes components that enable customers to manage supplies in real-time. The order system 202 includes software applications or a platform that streamlines and automates the process of ordering and managing supplies within an organization, such as a hotel. It runs on computer hardware, such as servers, desktops, laptops, or mobile devices, and provides comprehensive features like inventory management, purchase order creation, supplier management, order tracking, approval workflows, and reporting and/or analytics. By automating manual processes and reducing paperwork, it increases efficiency and accuracy while optimizing inventory levels and negotiating better prices with suppliers. Real-time visibility into inventory, orders, and spending allows for informed decision-making, ultimately leading to cost savings and improved supply chain management for organizations of all sizes. The required hardware depends on the size and complexity of the system, ranging from a single computer for smaller businesses to a network of servers for larger enterprises.

In embodiments, the order system 202 includes an order synchronization service 206, a personalized storefront 208, and a budget synchronization service 210. In embodiments, the order synchronization service 206 may communicate with one or more supplier system 204. The order synchronization service 206 includes software that automatically consolidates and synchronizes customer order data from various sources, including the supplier systems 204. In some instances, the order synchronization service 206 may also collect data from online stores, point-of-sale systems, and third-party marketplaces. The order synchronization service 206 extracts data from disparate platforms, transforming it into a unified format, and integrating it with a central database or system. The order synchronization service 206 provides a complete view of customer purchase history (e.g., order, invoice, and/or spend histories). Additionally, it enables personalized marketing campaigns based on analyzed purchase patterns and streamlines operations by reducing manual data entry and errors. Ultimately, this service facilitates data-driven decision-making, helping businesses identify trends, optimize inventory, and improve overall performance. The order synchronization service 206 can incorporate real-data data (e.g., via one or more web services) and offline data (e.g., CSV data).

Similarly, the budget synchronization service 210 is also a software tool or feature that automates the process of updating and aligning budget data across multiple platforms, devices, or applications. In some instances, the budget synchronization service 210 establishes connections with one or more resource planning system 212 to gather budget data. The budget synchronization service 210 may also collect data from financial accounts, budgeting apps, or software tools, and this data may include ERP data (e.g., receiving data, budgets, supplier data). The budget synchronization service 210 enables regular synchronization of budget information. In embodiments, the budget synchronization service 210 reconciles data from different sources to ensure accuracy and consistency, presenting the synchronized budget data in a user-friendly format through charts, graphs, and/or dashboards. The budget synchronization service 210 can incorporate real-data data (e.g., via one or more web services) and offline data (e.g., CSV data).

The budget synchronization service 210 is integrated with a resource planning system 212, such as a resource planning system, an accounting platform, or an enterprise resource planning (ERP) system. The budget synchronization service 210 streamlines the transfer and reconciliation of financial data between the two platforms. By automatically extracting relevant budget and financial data from the resource planning system 212, transforming it into a compatible format, and synchronizing it with connected budgeting tools or platforms, it ensures real-time updates and accuracy. The budget synchronization service 210 also reconciles budget data with actual financial data from the resource planning system 212, identifying discrepancies and generating reports for analysis.

Data often arrives in one or more PDFs or inconsistent formats. As such, it must be structured and standardized into a consistent format for cross-system compatibility. This is accomplished using a unform data layer. The uniform data layer includes a translation layer that reconciles diverse document designs and data fields against the expectations of ERPs or accounting platforms, which have varying validations and requirements. Some products, such as food and beverage have added complexities. Standardizing data associated with these products includes handling out-of-measure discrepancies, bulk discounts, and diverse catalog standard across suppliers/vendors. Services have their own complexities as well. Namely, services can be invoiced by retainers, minimums, hours, or units (e.g., laundry by the pound), each requiring standardizing. The order system 202 can user artificial intelligence (AI) tools and supplier-specific formats to streamline ingestion, unification, and integration of disparate sources.

In some embodiments, transforming the extracted budget and financial data and order data into a compatible format may include establishing a standardized structure for the final dataset. The process typically begins with data extraction, where relevant fields (e.g., vendor name, item description, quantity, cost, date, etc.) are pulled from each source using tools like OCR for scanned documents, spreadsheet parsers, or API integrations for software platforms. Once extracted, the data must be cleaned and normalized, which involves correcting inconsistencies in naming conventions, units of measurement, date formats, and categorization. After normalization, the data can be mapped to a unified schema, a consistent format that defines how each data type should be represented (e.g., all dates in YYYY-MM-DD format, all costs in the same currency). This schema can be implemented in a database or a master document. Finally, the compiled data can be validated to ensure accuracy and completeness, often by cross-referencing totals or checking for missing entries.

The order system 202 includes one or more personalized storefront 208 to present data to a customer and/or provide other features and services discussed herein. The personalized storefront 208 may present data in a mobile application on a mobile device, and/or a desktop application on a desktop computer. The data may include products or services for procurement from the supplier 204 including images, descriptions, model or serial numbers, or other descriptive features of the products or services for procurement.

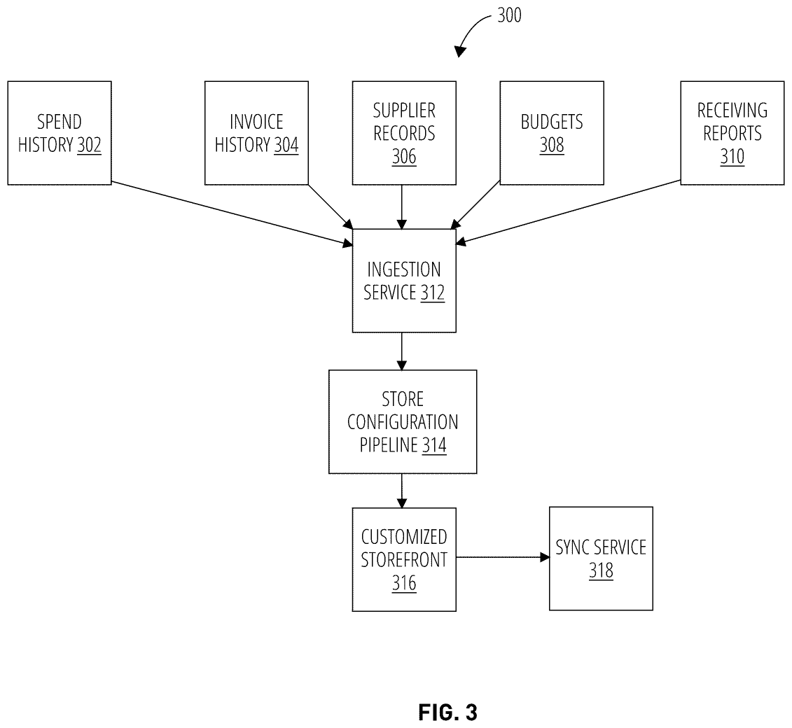

FIG. 3 illustrates a process flow 300 for custom store creation for optimized mobile purchasing at an entity in accordance with embodiments. In the process flow 300, spend history 302, invoice history 302, supplier records 306, budgets 308, and receiving reports 301 can be retrieved and provided to an ingestion service 312. The ingestion service 312 can receive these materials and can analyze or otherwise manipulate the data contained therein and generate additional data therefrom as discussed herein in support of the custom store generation. For example, product serial numbers, model numbers, descriptions, prices, etc. can be obtained from the spending history 302, invoice history 304, supplier records 306, budgets 308, and receiving reports 310. The ingestion service can extract the data related to the products and services and transform it as discussed above. In some embodiments, the ingestion service 312 can also extract the account number or account identifier assigned to the entity for the particular supplier or vendor. This account number or account identifier can be used to create a profile with the third-party vendor or supplier.

The ingestion service 312 can provide the output of the results of its data analysis and manipulation, the generated additional data, and/or the received materials to the store configuration pipeline 314. The store configuration pipeline 314 can receive the output from the ingestion service 312 and perform further data analysis, manipulation, and generation in support of the custom store generation. In addition, the store configuration pipeline 314 can prepare the configuration of the custom store, along with the supporting data and infrastructure, as discussed herein.

The store configuration pipeline 314 may include generating a custom website with the GUI that displays the custom storefront for the entity. The custom storefront may display or list goods and services on the GUI from one or more different third-party vendors or suppliers. The store configuration pipeline is implemented using the processing circuit 104 described above. The store configuration pipeline 314 can further engage network infrastructure such as switches, routers, servers and the like to operate the custom storefront. For example, the store configuration pipeline 314 and the hardware devices (e.g., the computing device 102 and/or order system 202 described above) that implement the store configuration pipeline 314 can send instructions to the network and server infrastructure to generate the custom storefront according to specifications. The specifications can include which products and services to display on the GUI of the customized storefront. Moreover, the specifications can be determined based on the analysis and data collection performed by the ingestion service 312.

For example, the ingestion service 312 can collect and identify the products and services and other data discussed above, and generate instructions for generating a customized storefront (e.g., website, web application, mobile site, intranet, etc.) to display and facilitate procurement of the products and services.

The store configuration pipeline 314 can provide data, infrastructure, and configuration for the customized storefront 316. The customized storefront 316 can present a storefront and a buying and ordering experience for users, including users of mobile devices, as discussed herein. The customized storefront 316 can interact with synchronization service 318 to provide and obtain data as discussed herein, including ongoing and/or continuous catalog synchronization as described herein.

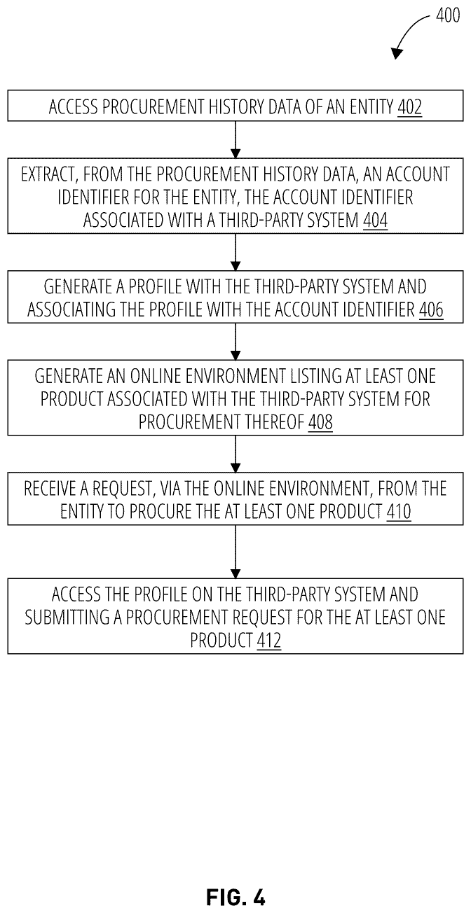

FIG. 4 is a flow chart illustrating some example operations performed in a method 400 for generating a customized online environment for procuring products and services. As shown at block 402, the method 400 includes accessing procurement history data of an entity. As shown at block 404, the method 400 includes extracting, from the procurement history data, an account identifier for the entity, the account identifier associated with a third-party system. As shown at block 406, the method 400 includes generating a profile with the third-party system and associating the profile with the account identifier. As shown at block 408, the method 400 includes generating an online environment listing at least one product associated with the third-party system for procurement thereof. As shown at block 410, the method 400 includes receiving a request, via the online environment, from the entity to procure the at least one product. As shown at block 412, the method 400 includes accessing the profile on the third-party system and submitting a procurement request for the at least one product.

In some embodiments, the procurement history data includes one or more of invoice data, purchase history data, a receipt, or order history data. In some embodiments, the account identifier is an account number with the third-party system, where the account number is assigned to the entity. In some embodiments, the third-party system is a merchant website, online retail or wholesale website, or a website for ordering goods and services.

In some embodiments, generating the profile with the third-party system includes communicating with the third-party system to create the profile using new log-in credentials; and sending a request to the third-party system to associate the profile with the account identifier. In some embodiments, generating the online environment listing the at least one product associated with the third-party system includes generating an online environment configured as a personalized storefront for the entity, wherein the personalized storefront includes a graphical user interface (GUI) to display or list the at least one product. In some embodiments, the method 400 further comprises performing an analysis on the procurement history data to determine the at least one product from the procurement history; and displaying the at least one product on the GUI of the personalized storefront.

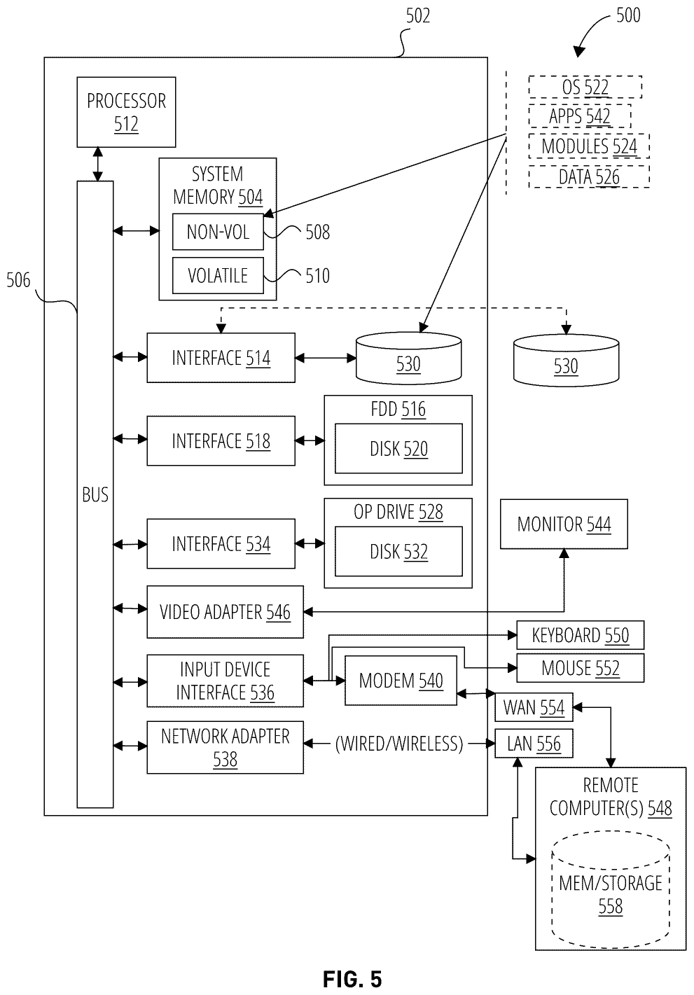

FIG. 5 illustrates an embodiment of an exemplary computer architecture 500 suitable for implementing various embodiments as previously described, such as the computing device 102 of FIG. 1 or the order system 202 of FIG. 2. In one embodiment, the computer architecture 500 may include or be implemented as part of one or more systems or devices discussed herein.

As used in this application, the terms “system” and “component” are intended to refer to a computer-related entity, either hardware, a combination of hardware and software, software, or software in execution, examples of which are provided by the exemplary computing computer architecture 500. For example, a component can be, but is not limited to being, a process running on a processor, a processor, a hard disk drive, multiple storage drives (of optical and/or magnetic storage medium), an object, an executable, a thread of execution, a program, and/or a computer. By way of illustration, both an application running on a server and the server can be a component. One or more components can reside within a process and/or thread of execution, and a component can be localized on one computer and/or distributed between two or more computers. Further, components may be communicatively coupled to each other by various types of communications media to coordinate operations. The coordination may involve the uni-directional or bi-directional exchange of information. For instance, the components may communicate information in the form of signals communicated over the communications media. The information can be implemented as signals allocated to various signal lines. In such allocations, each message is a signal. Further embodiments, however, may alternatively employ data messages. Such data messages may be sent across various connections. Exemplary connections include parallel interfaces, serial interfaces, and bus interfaces.

The computing architecture 500 includes various common computing elements, such as one or more processors, multi-core processors, co-processors, memory units, chipsets, controllers, peripherals, interfaces, oscillators, timing devices, video cards, audio cards, multimedia input/output (I/O) components, power supplies, and so forth. The embodiments, however, are not limited to implementation by the computing architecture 500.

As shown in FIG. 5, the computing architecture 500 includes a processor 512, a system memory 504 and a system bus 506. The processor 512 can be any of various commercially available processors.

The system bus 506 provides an interface for system components including, but not limited to, the system memory 504 to the processor 512. The system bus 506 can be any of several types of bus structure that may further interconnect to a memory bus (with or without a memory controller), a peripheral bus, and a local bus using any of a variety of commercially available bus architectures. Interface adapters may connect to the system bus 608 via slot architecture. Example slot architectures may include without limitation Accelerated Graphics Port (AGP), Card Bus, (Extended) Industry Standard Architecture ((E)ISA), Micro Channel Architecture (MCA), NuBus, Peripheral Component Interconnect (Extended) (PCI(X)), PCI Express, Personal Computer Memory Card International Association (PCMCIA), and the like.

The computing architecture 500 may include or implement various articles of manufacture. An article of manufacture may include a computer-readable storage medium to store logic. Examples of a computer-readable storage medium may include any tangible media capable of storing electronic data, including volatile memory or non-volatile memory, removable or non-removable memory, erasable or non-erasable memory, writeable or re-writeable memory, and so forth. Examples of logic may include executable computer program instructions implemented using any suitable type of code, such as source code, compiled code, interpreted code, executable code, static code, dynamic code, object-oriented code, visual code, and the like. Embodiments may also be at least partly implemented as instructions contained in or on a non-transitory computer-readable medium, which may be read and executed by one or more processors to enable performance of the operations described herein.

The system memory 504 may include various types of computer-readable storage media in the form of one or more higher speed memory units, such as read-only memory (ROM), random-access memory (RAM), dynamic RAM (DRAM), Double-Data-Rate DRAM (DDRAM), synchronous DRAM (SDRAM), static RAM (SRAM), programmable ROM (PROM), erasable programmable ROM (EPROM), electrically erasable programmable ROM (EEPROM), flash memory, polymer memory such as ferroelectric polymer memory, ovonic memory, phase change or ferroelectric memory, silicon-oxide-nitride-oxide-silicon (SONOS) memory, magnetic or optical cards, an array of devices such as Redundant Array of Independent Disks (RAID) drives, solid state memory devices (e.g., USB memory, solid state drives (SSD) and any other type of storage media suitable for storing information. In the illustrated embodiment shown in FIG. 5, the system memory 504 can include non-volatile 508 and/or volatile 510. A basic input/output system (BIOS) can be stored in the non-volatile 508.

The computer 502 may include various types of computer-readable storage media in the form of one or more lower speed memory units, including an internal (or external) hard disk drive 530, a magnetic disk drive 516 to read from or write to a removable magnetic disk 520, and an optical disk drive 528 to read from or write to a removable optical disk 532 (e.g., a CD-ROM or DVD). The hard disk drive 530, magnetic disk drive 516 and optical disk drive 528 can be connected to system bus 506 the by an HDD interface 514, and FDD interface 518 and an optical disk drive interface 534, respectively. The HDD interface 514 for external drive implementations can include at least one or both of Universal Serial Bus (USB) and IEEE 1394 interface technologies.

The drives and associated computer-readable media provide volatile and/or nonvolatile storage of data, data structures, computer-executable instructions, and so forth. For example, a number of program modules can be stored in the drives and non-volatile 508, and volatile 510, including an operating system 522, one or more applications 542, other program modules 524, and program data 526. In one embodiment, the one or more applications 542, other program modules 524, and program data 526 can include, for example, the various applications and/or components of the systems discussed herein.

A user can enter commands and information into the computer 502 through one or more wire/wireless input devices, for example, a keyboard 550 and a pointing device, such as a mouse 552. Other input devices may include microphones, infra-red (IR) remote controls, radio-frequency (RF) remote controls, game pads, stylus pens, card readers, dongles, finger print readers, gloves, graphics tablets, joysticks, keyboards, retina readers, touch screens (e.g., capacitive, resistive, etc.), trackballs, track pads, sensors, styluses, and the like. These and other input devices are often connected to the processor 512 through an input device interface 536 that is coupled to the system bus 506 but can be connected by other interfaces such as a parallel port, IEEE 1394 serial port, a game port, a USB port, an IR interface, and so forth.

A monitor 544 or other type of display device is also connected to the system bus 506 via an interface, such as a video adapter 546. The monitor 544 may be internal or external to the computer 502. In addition to the monitor 544, a computer typically includes other peripheral output devices, such as speakers, printers, and so forth.

The computer 502 may operate in a networked environment using logical connections via wire and/or wireless communications to one or more remote computers, such as a remote computer(s) 548. The remote computer(s) 548 can be a workstation, a server computer, a router, a personal computer, portable computer, microprocessor-based entertainment appliance, a peer device or other common network node, and typically includes many or all the elements described relative to the computer 502, although, for purposes of brevity, only a memory and/or storage device 558 is illustrated. The logical connections depicted include wire/wireless connectivity to a local area network 556 and/or larger networks, for example, a wide area network 554. Such LAN and WAN networking environments are commonplace in offices and companies, and facilitate enterprise-wide computer networks, such as intranets, all of which may connect to a global communications network, for example, the Internet.

When used in a local area network 556 networking environment, the computer 502 is connected to the local area network 556 through a wire and/or wireless communication network interface or network adapter 538. The network adapter 538 can facilitate wire and/or wireless communications to the local area network 556, which may also include a wireless access point disposed thereon for communicating with the wireless functionality of the network adapter 538.

When used in a wide area network 554 networking environment, the computer 502 can include a modem 540, or is connected to a communications server on the wide area network 554 or has other means for establishing communications over the wide area network 554, such as by way of the Internet. The modem 540, which can be internal or external and a wire and/or wireless device, connects to the system bus 506 via the input device interface 536. In a networked environment, program modules depicted relative to the computer 502, or portions thereof, can be stored in the remote memory and/or storage device 558. It will be appreciated that the network connections shown are exemplary and other means of establishing a communications link between the computers can be used.

The computer 502 is operable to communicate with wire and wireless devices or entities using the IEEE 802 family of standards, such as wireless devices operatively disposed in wireless communication (e.g., IEEE 802.11 over-the-air modulation techniques). This includes at least Wi-Fi (or Wireless Fidelity), WiMax, and Bluetooth™ wireless technologies, among others. Thus, the communication can be a predefined structure as with a conventional network or simply an ad hoc communication between at least two devices. Wi-Fi networks use radio technologies called IEEE 802.11 (a, b, g, n, etc.) to provide secure, reliable, fast wireless connectivity. A Wi-Fi network can be used to connect computers to each other, to the Internet, and to wire networks (which use IEEE 802.3-related media and functions).

The various elements of the devices as previously described herein may include various hardware elements, software elements, or a combination of both. Examples of hardware elements may include devices, logic devices, components, processors, microprocessors, circuits, processors, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), memory units, logic gates, registers, semiconductor device, chips, microchips, chip sets, and so forth. Examples of software elements may include software components, programs, applications, computer programs, application programs, system programs, software development programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. However, determining whether an embodiment is implemented using hardware elements and/or software elements may vary in accordance with any number of factors, such as desired computational rate, power levels, heat tolerances, processing cycle budget, input data rates, output data rates, memory resources, data bus speeds and other design or performance constraints, as desired for a given implementation.

The components and features of the devices described above may be implemented using any combination of discrete circuitry, application specific integrated circuits (ASICs), logic gates and/or single chip architectures. Further, the features of the devices may be implemented using microcontrollers, programmable logic arrays and/or microprocessors or any combination of the foregoing where suitably appropriate. It is noted that hardware, firmware and/or software elements may be collectively or individually referred to herein as “logic” or “circuit.”

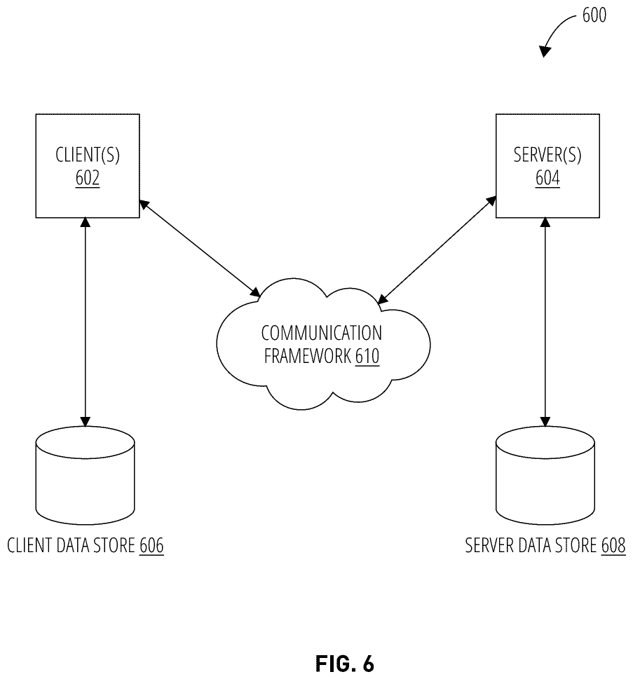

FIG. 6 is a block diagram depicting an exemplary communications architecture 600 suitable for implementing various embodiments as previously described. The communications architecture 600 includes various common communications elements, such as a transmitter, receiver, transceiver, radio, network interface, baseband processor, antenna, amplifiers, filters, power supplies, and so forth. The embodiments, however, are not limited to implementation by the communications architecture 600, which may be consistent with systems and devices discussed herein.

As shown in FIG. 6, the communications architecture 600 includes one or more client(s) 602 and server(s) 604. The server(s) 604 may implement one or more functions and embodiments discussed herein. The client(s) 602 and the server(s) 604 are operatively connected to one or more respective client data store 606 and server data store 608 that can be employed to store information local to the respective client(s) 602 and server(s) 604, such as cookies and/or associated contextual information.

The client(s) 602 and the server(s) 604 may communicate information between each other using a communication framework 610. The communication framework 610 may implement any well-known communications techniques and protocols. The communication framework 610 may be implemented as a packet-switched network (e.g., public networks such as the Internet, private networks such as an enterprise intranet, and so forth), a circuit-switched network (e.g., the public switched telephone network), or a combination of a packet-switched network and a circuit-switched network (with suitable gateways and translators).

The communication framework 610 may implement various network interfaces arranged to accept, communicate, and connect to a communications network. A network interface may be regarded as a specialized form of an input/output (I/O) interface. Network interfaces may employ connection protocols including without limitation direct connect, Ethernet (e.g., thick, thin, twisted pair 10/100/1000 Base T, and the like), token ring, wireless network interfaces, cellular network interfaces, IEEE 802.7a-x network interfaces, IEEE 802.16 network interfaces, IEEE 802.20 network interfaces, and the like. Further, multiple network interfaces may be used to engage with various communications network types. For example, multiple network interfaces may be employed to allow for the communication over broadcast, multicast, and unicast networks. Should processing requirements dictate a greater amount speed and capacity, distributed network controller architectures may similarly be employed to pool, load balance, and otherwise increase the communicative bandwidth required by client(s) 602 and the server(s) 604. A communications network may be any one and the combination of wired and/or wireless networks including without limitation a direct interconnection, a secured custom connection, a private network (e.g., an enterprise intranet), a public network (e.g., the Internet), a Personal Area Network (PAN), a Local Area Network (LAN), a Metropolitan Area Network (MAN), an Operating Missions as Nodes on the Internet (OMNI), a Wide Area Network (WAN), a wireless network, a cellular network, and other communications networks.

In some examples, exemplary procedures in accordance with the present disclosure described herein can be performed by a processing arrangement and/or a computing arrangement (e.g., a computer hardware arrangement). Such processing and/or computing arrangement can be, for example entirely or a part of, or include, but not limited to, a computer/processor that can include, for example one or more microprocessors, and use instructions stored on a computer-accessible medium (e.g., RAM, ROM, hard drive, or other storage device). For example, a computer-accessible medium can be part of the memory of a user device, a authorization server, a server, or other computer hardware arrangement.

In some examples, a computer-accessible medium (e.g., as described herein above, a storage device such as a hard disk, floppy disk, memory stick, CD-ROM, RAM, ROM, etc., or a collection thereof) can be provided (e.g., in communication with the processing arrangement). The computer-accessible medium can contain executable instructions thereon. In addition or alternatively, a storage arrangement can be provided separately from the computer-accessible medium, which can provide the instructions to the processing arrangement so as to configure the processing arrangement to execute certain exemplary procedures, processes, and methods, as described herein above, for example.

It is further noted that the systems and methods described herein may be tangibly embodied in one or more physical media, such as, but not limited to, a compact disc (CD), a digital versatile disc (DVD), a floppy disk, a hard drive, read only memory (ROM), random access memory (RAM), as well as other physical media capable of data storage. For example, data storage may include random access memory (RAM) and read only memory (ROM), which may be configured to access and store data and information and computer program instructions. Data storage may also include storage media or other suitable type of memory (e.g., such as, for example, RAM, ROM, programmable read-only memory (PROM), erasable programmable read-only memory (EPROM), electrically erasable programmable read-only memory (EEPROM), magnetic disks, optical disks, floppy disks, hard disks, removable cartridges, flash drives, and any type of tangible and non-transitory storage medium), where the files that comprise an operating system, application programs including, for example, web browser application, email application and/or other applications, and data files may be stored. The data storage of the network-enabled computer systems may include electronic information, files, and documents stored in various ways, including, for example, a flat file, indexed file, hierarchical database, relational database, such as a database created and maintained with software from, for example, Oracle® Corporation, Microsoft® Excel file, Microsoft® Access file, a solid state storage device, which may include a flash array, a hybrid array, or a server-side product, enterprise storage, which may include online or cloud storage, or any other storage mechanism. Moreover, the figures illustrate various components (e.g., servers, computers, processors, etc.) separately. The functions described as being performed at various components may be performed at other components, and the various components may be combined or separated. Other modifications also may be made.

Computer readable program instructions described herein can be downloaded to respective computing and/or processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing and/or processing device receives computer readable program instructions from the network and forwards the computer readable program instructions for storage in a computer readable storage medium within the respective computing and/or processing device.

Computer readable program instructions for carrying out operations of the present disclosure may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Java, Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, to perform aspects of the present disclosure.

These computer readable program instructions may be provided to a processor of a general-purpose computer, special purpose computer, or other programmable data processing apparatus to produce a machine, such that the instructions, which execute via the processor of the computer or other programmable data processing apparatus, create means for implementing the functions specified herein. These computer-readable program instructions may also be stored in a computer-readable storage medium that can direct a computer, a programmable data processing apparatus, and/or other devices to function in a manner, such that the computer readable storage medium having instructions stored therein comprises an article of manufacture including instructions which implement aspects of the functions specified herein.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions specified herein.

Implementations of the various techniques described herein may be implemented in digital electronic circuitry, or in computer hardware, firmware, software, or in combinations of them. Implementations may be implemented as a computer program product, i.e., a computer program tangibly embodied in an information carrier, e.g., in a machine readable storage device or in a propagated signal, for execution by, or to control the operation of, data processing apparatus, e.g., a programmable processor, a computer, or multiple computers. A computer program, such as the computer program(s) described above, can be written in any form of programming language, including compiled or interpreted languages, and can be deployed in any form, including as a stand-alone program or as a module, component, subroutine, or other unit suitable for use in a computing environment. A computer program can be deployed to be executed on one computer or on multiple computers at one site or distributed across multiple sites and interconnected by a communication network.

Method steps may be performed by one or more programmable processors executing a computer program to perform functions by operating on input data and generating output. Method steps also may be performed by, and an apparatus may be implemented as, special purpose logic circuitry, e.g., an FPGA (field programmable gate array) or an ASIC (application specific integrated circuit).

Throughout the disclosure, the following terms take at least the meanings explicitly associated herein, unless the context clearly dictates otherwise. The term “or” is intended to mean an inclusive “or.” Further, the terms “a,” “an,” and “the” are intended to mean one or more unless specified otherwise or clear from the context to be directed to a singular form.

In this description, numerous specific details have been set forth. It is to be understood, however, that implementations of the disclosed technology may be practiced without these specific details. In other instances, well-known methods, structures and techniques have not been shown in detail in order not to obscure an understanding of this description. References to “some examples,” “other examples,” “one example,” “an example,” “various examples,” “one embodiment,” “an embodiment,” “some embodiments,” “example embodiment,” “various embodiments,” “one implementation,” “an implementation,” “example implementation,” “various implementations,” “some implementations,” etc., indicate that the implementation(s) of the disclosed technology so described may include a particular feature, structure, or characteristic, but not every implementation necessarily includes the particular feature, structure, or characteristic. Further, repeated use of the phrases “in one example,” “in one embodiment,” or “in one implementation” does not necessarily refer to the same example, embodiment, or implementation, although it may.

As used herein, unless otherwise specified the use of the ordinal adjectives “first,” “second,” “third,” etc., to describe a common object, merely indicate that different instances of like objects are being referred to, and are not intended to imply that the objects so described must be in a given sequence, either temporally, spatially, in ranking, or in any other manner.

While certain implementations of the disclosed technology have been described in connection with what is presently considered to be the most practical and various implementations, it is to be understood that the disclosed technology is not to be limited to the disclosed implementations, but on the contrary, is intended to cover various modifications and equivalent arrangements included within the scope of the appended claims. Although specific terms are employed herein, they are used in a generic and descriptive sense only and not for purposes of limitation.

This written description uses examples to disclose certain implementations of the disclosed technology, including the best mode, and also to enable any person skilled in the art to practice certain implementations of the disclosed technology, including making and using any devices or systems and performing any incorporated methods. The patentable scope of certain implementations of the disclosed technology is defined in the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A method comprising:
accessing procurement history data of an entity;
extracting, from the procurement history data, an account identifier for the entity, the account identifier associated with a third-party system;
generating a profile with the third-party system and associating the profile with the account identifier;
generating an online environment listing at least one product associated with the third-party system for procurement thereof;
receiving a request, via the online environment, from the entity to procure the at least one product; and
accessing the profile on the third-party system and submitting a procurement request for the at least one product.

2. The method of claim 1, wherein the procurement history data includes one or more of invoice data, purchase history data, a receipt, or order history data.

3. The method of claim 1, wherein the account identifier is an account number with the third-party system, where the account number is assigned to the entity.

4. The method of claim 1, wherein the third-party system is a merchant website, online retail or wholesale website, or a website for ordering goods and services.

5. The method of claim 1, wherein generating the profile with the third-party system includes:
communicating with the third-party system to create the profile using new log-in credentials; and
sending a request to the third-party system to associate the profile with the account identifier.

6. The method of claim 1, wherein generating the online environment listing the at least one product associated with the third-party system includes generating an online environment configured as a personalized storefront for the entity, wherein the personalized storefront includes a graphical user interface (GUI) to display or list the at least one product.

7. The method of claim 6, further comprising:
performing an analysis on the procurement history data to determine the at least one product from the procurement history data; and
displaying the at least one product on the GUI of the personalized storefront.

8. A system comprising:
a processing circuit; and
a memory coupled to the processing circuit, the memory including instructions which when executed by the processing circuit cause the processing circuit to:
access procurement history data of an entity;
extract, from the procurement history data, an account identifier for the entity, the account identifier associated with a third-party system;
generate a profile with the third-party system and associate the profile with the account identifier;
generate an online environment listing at least one product associated with the third-party system for procurement thereof;
receive a request, via the online environment, from the entity to procure the at least one product; and
access the profile on the third-party system and submit a procurement request for the at least one product.

9. The system of claim 8, wherein the procurement history data includes one or more of invoice data, purchase history data, a receipt, or order history data.

10. The system of claim 8, wherein the account identifier is an account number with the third-party system, where the account number is assigned to the entity.

11. The system of claim 8, wherein the third-party system is a merchant website, online retail or wholesale website, or a website for ordering goods and services.

12. The system of claim 8, wherein generating the profile with the third-party system includes the processing circuit being configured to:
communicate with the third-party system to create the profile using new log-in credentials; and
send a request to the third-party system to associate the profile with the account identifier.

13. The system of claim 8, wherein generating the online environment listing the at least one product associated with the third-party system includes the processing circuit being configured to generate an online environment configured as a personalized storefront for the entity, wherein the personalized storefront includes a graphical user interface (GUI) to display or list the at least one product.

14. The system of claim 13, wherein the processing circuit is further configured to:
perform an analysis on the procurement history data to determine the at least one product from the procurement history data; and
display the at least one product on the GUI of the personalized storefront.

15. A non-transitory computer-readable storage medium having executable instructions stored thereon, which when executed by the processing circuit cause the processing circuit to:
access procurement history data of an entity;
extract, from the procurement history data, an account identifier for the entity, the account identifier associated with a third-party system;
generate a profile with the third-party system and associate the profile with the account identifier;
generate an online environment listing at least one product associated with the third-party system for procurement thereof;
receive a request, via the online environment, from the entity to procure the at least one product; and
access the profile on the third-party system and submit a procurement request for the at least one product.

16. The non-transitory computer-readable storage medium of claim 15, wherein the procurement history data includes one or more of invoice data, purchase history data, a receipt, or order history data; and
wherein the account identifier is an account number with the third-party system, where the account number is assigned to the entity.

17. The non-transitory computer-readable storage medium of claim 15, wherein the third-party system is a merchant website, online retail or wholesale website, or a website for ordering goods and services.

18. The non-transitory computer-readable storage medium of claim 15, wherein generating the profile with the third-party system includes the processing circuit being configured to:
communicate with the third-party system to create the profile using new log-in credentials; and
send a request to the third-party system to associate the profile with the account identifier.

19. The non-transitory computer-readable storage medium of claim 15, wherein generating the online environment listing the at least one product associated with the third-party system includes the processing circuit being configured to generate an online environment configured as a personalized storefront for the entity, wherein the personalized storefront includes a graphical user interface (GUI) to display or list the at least one product.

20. The non-transitory computer-readable storage medium of claim 19, wherein the processing circuit is further configured to:
perform an analysis on the procurement history data to determine the at least one product from the procurement history data; and
display the at least one product on the GUI of the personalized storefront.
